(19) United States
(12) Patent Application Publication
(10) Pub. No.: US 2009/0226275 A1
(43) Pub. Date: Sep. 10, 2009

(54) Metal conduit inserted monomer cast nylon support block producing method and monomer cast nylon support block producing thereof

(75) Inventor: Jun Seo Park, Taejun Metrocity (KR)

Correspondence Address: W. NORMAN ROTH, 523 W. 6TH STREET, SUITE 707, LOS ANGELES, CA, 90014, US

(73) Assignees: Hae Su Jung, Taegu Metrocity (KR); SNM Co., Ltd., Kyungsangnam-do (KR)

(21) Appl. No.: 12/228,821

(22) Filed: Aug. 15, 2008

Related U.S. Application Data
(60) Provisional application No. 61/068,596, filed on Mar. 7, 2008.

(51) Int. Cl. B60P 7/06; C08J 5/02

(52) U.S. Cl. 410/49; 264/331.12

(57) ABSTRACT

A detachable nylon elastomer support block is disclosed, which can be easily attached to a transportation vehicle like a transportation trailer, and in particular to a metal conduit-inserted nylon elastomer support block and its manufacturing method which are able to tolerate a large impact and a low temperature.

### RELATED APPLICATIONS

This application claims the benefit under 35 USC Sec. 119 of U.S. Provisional Application Ser. No. 61/068,596 filed Mar. 7, 2008 in the name of inventor PARK, Jun Seo.

### TECHNICAL FIELD

The present invention relates to a MC nylon elastomer support block which makes it possible to stably store an intermediate or large size steel roll having a heavy weight in a manufacturing site or a distribution warehouse, and a detachable MC nylon elastomer support block which can be easily attached to a transportation vehicle like a transportation trailer, and in particular to a metal conduit-inserted MC nylon elastomer support block and its manufacturing method which are able to tolerate a large impact and a low temperature.

### BACKGROUND ART

The steel fixing support unit for a transportation vehicle, which is able to transport a large size roll like a steel coil, is made up of wood or rubber, and its construction is very weak. The large size steel coils are generally stored with the helps of wooden or rubber blocks. As shown in FIG. 1, a support unit 4 generally made up of wood (tie) or rubber is installed on a loading plate 5 of a steel coil transportation vehicle. A fixing chain ring 6 is installed at both sides of s the loading plate 5, so a large size roll 1 is tied by means of the chain 3.

As shown in FIG. 1, when the large size roll 1 like a steel coil or something is transported, the large size roll 1 is mounted on the support unit 4, and the chain 3 passes through the chain ring 6 installed in one side of the loading plate 5 and is extended across an inner space 2 of the steel roll and is finally connected to a ring 6 installed in the loading plate 5 of the other side. However, the above conventional fixing structure is not proper when a heavy large size steel product is transported, which leads to a large accident.

In case of a wooden fixing structure, it does not cost much, but when it is used for a long time in an outdoor space, its physical property may change is due to sunshine and moisture. Since the wooden fixing structure does not have substantial compression strength, when it is used for a long time, the wooden fixing structure may be transformed or broken, which leads to a frequent change with new one. In worse case, the wooden fixing structure may be broken by means of an instant strong impact when transporting a heavy steel product. In case of a support block made up of a conventional wooden or rubber structure, it is needed to fix the same on the floor of a transportation vehicle. So, it is very difficult to process the structure in a proper shape and construction for substantially supporting a heavy steel product to be transported. In this case, it may be simply used as a support member.

In case of a rubber fixing structure, it has a better performance and can be formed in various shapes when used in an outdoor space. However, compression strength is weak for reliably supporting a heavy steel product. It is very hard for processing in various shapes for enhancing a close contact performance with a steel product. So, it may be simply used as a support like the wooden fixing structure. In order to overcome the above problems, there is a method for manufacturing a large size support block having a size of 1 through 2 meters, and there is a monomer casting (MC) nylon, which is generally made in a casting process. During the manufacturing process, a metal conduit is installed in a support block shaped mold and is synthesized for thereby manufacturing a metal conduit inserted MC nylon support block. The MC nylon has high tensional strength, high bending strength and high compression strength, which lead to being used as a support block for supporting a heavy metal coil or something. However, an impact strength decreases when it is under a zero temperature in winter, so it is needed to supplement an impact strength by reforming a chemical property of a material.

### DISCLOSURE OF THE INVENTION

Accordingly, it is an object of the present invention to provide a metal conduit-inserted MC nylon elastomer support block and its manufacturing method which make it possible to stably support a heavy steel product and which can be manufactured through a similar manufacture process without greatly changing a mechanical property and thermal resistance of MC nylon. In the industry, it is urgently needed to develop a new support block which is equipped with a greatly improved impact strength.

To achieve the above objects, there are provided a support block for a steel product transportation vehicle and its manufacturing method which are made by using a nylon elastomer manufactured by mixing a polymer polyester polyol or a poly ether polyol of which its both ends are substituted with isocyanate during a polymerization process instead of isocyanate compound, which is an initiator. The nylon elastomer is prepared in the same process as the polymerization of the MC nylon along with its lightness like MC nylon. The support block may be used as a block for storing a large size steel roll in a manufacturing site or a distribution warehouse.

The MC nylon belongs to nylon 6 in its molecular structure. It is greatly different from a nylon which is processed through a compression molding work or an injection molding work by using nylon which is synthesized by a condensation polymerization in a view that an anion polymerization occurs in a mold under the presence of basic catalyst. The important features of the anion polymerization resides in that a reaction fast occurs at a lower temperature since a reaction activation energy is low, and as the reaction is proceeded, a nylon having high crystallinity of liquid monomer is prepared, and the MC nylon having a few hundreds of thousands of molecular is able to maintain a higher strength and heat resistance. In particular, when the MC nylon is molded through a casting process with the help of the characteristics of anion polymerization, various shapes of molds can be used. So, it is possible to directly manufacture various shapes of plastic products for example in a plate shape, a rod shape or a pipe shape. Various grooves can be advantageously formed in the product.

It should be appreciated that the MC nylon has the above advantages, which the MC nylon is widely used in an iron industry, a vehicle industry, a ship industry, an automation field, a metal industry, and a home appliance manufacturing industry. It should be further appreciated that the MC nylon can be used for manufacturing a large size product of above 1 m like a support block. Since the MC nylon has a strong strength, but its impact strength is weak. When it receives an impact under zero temperature in winter or it receives a sudden impact, the MC nylon may be broken. So, it is needed to improve an impact strength when used in an application which needs a high strength by reforming the characteristic of a MC nylon material.

The present invention is basically directed to a metal conduit-inserted block structure which is prepared with the helps of the characteristics of a nylon elastomer having an excellent mechanical strength and heat resistance and a casting manufacture technology which makes it possible to manufacture a large size product. The support block of the present invention can be used for stably supporting a heavy roll type steel product which is transported on the vehicle.

The present invention is basically directed to a manufacture of a MC nylon elastomer support block having an excellent mechanical strength and heat resistance. It is a principle object of the present invention to manufacture a support block having a greatly improved impact resistance performance with the help of a material reformation through synthesis while not decreasing a mechanical strength and heat resistance of the MC nylon. As a method for increasing an impact strength of the MC nylon, the impact resistance performance can be greatly enhanced by making a block copolymer having a A-B-A type with an anion polymerization mechanism, which is a MC nylon polymerization mechanism, in a repeating unit of a nylon A and a poly ether B polymer.

### BRIEF DESCRIPTION OF THE DRAWINGS

The present invention will become better understood with reference to the accompanying drawings which are given only by way of illustration and thus are not limitative of the present invention, wherein;

FIG. 1 is a side view illustrating a support structure of a conventional large size roll transportation vehicle;

FIG. 2 is a front view illustrating a state that a steel roll is mounted on a MC nylon elastomer support block according to the present invention;

FIGS. 3A through 3C are perspective views illustrating a MC nylon elastomer support block according to the present invention, of which:

FIG. 3A is a view illustrating a triangle metal conduit-inserted MC nylon elastomer support block;

FIG. 3B is a view illustrating another triangle metal conduit-inserted MC nylon elastomer support block; and

FIG. 3C is a view illustrating a circular metal conduit-inserted MC nylon elastomer support block;

FIGS. 4A through 4C are perspective views illustrating a state that a longitudinal groove is formed in a MC nylon elastomer support block, of which:

FIG. 4A is a view illustrating a longitudinal groove-formed MC nylon elastomer support block;

FIG. 4B is a cross sectional view illustrating a longitudinal groove-formed MC nylon elastomer support block; and

FIG. 4C is a view illustrating a state that a natural rubber or a synthetic rubber is inserted into a longitudinal groove as an elastomer material;

FIGS. 5A through 5C are perspective views illustrating a state that a spherical or semispherical groove is formed in a nylon elastomer support block according to the present invention, of which:

FIG. 5A is a view illustrating a spherical or semispherical groove-formed MC nylon elastomer support block;

FIG. 5B is a cross sectional view illustrating a spherical or semispherical groove-formed MC nylon elastomer support block; and

FIG. 5C is a view illustrating a state that a natural rubber or a synthetic rubber is inserted into a longitudinal groove as an elastomer material.

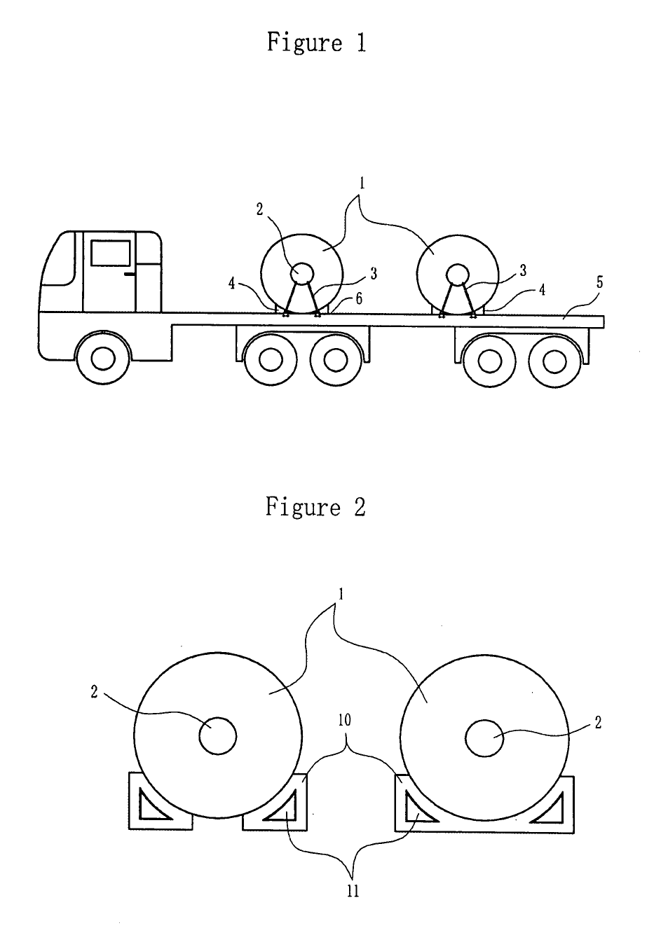

### MODES FOR CARRYING OUT THE INVENTION

The preferred embodiments of the present invention will be described with reference to the accompanying drawings.

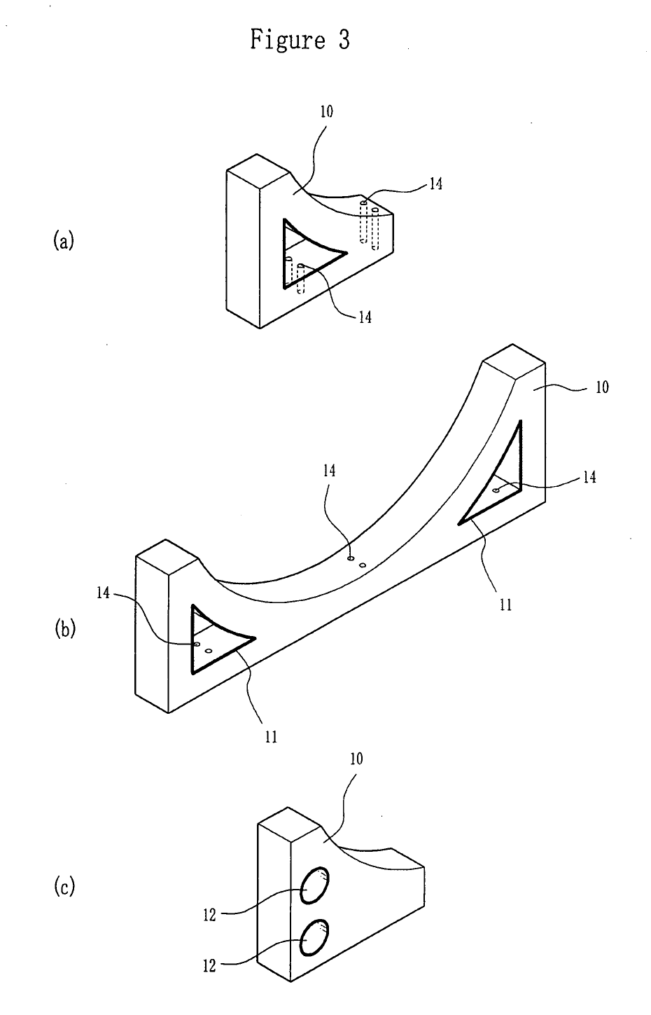

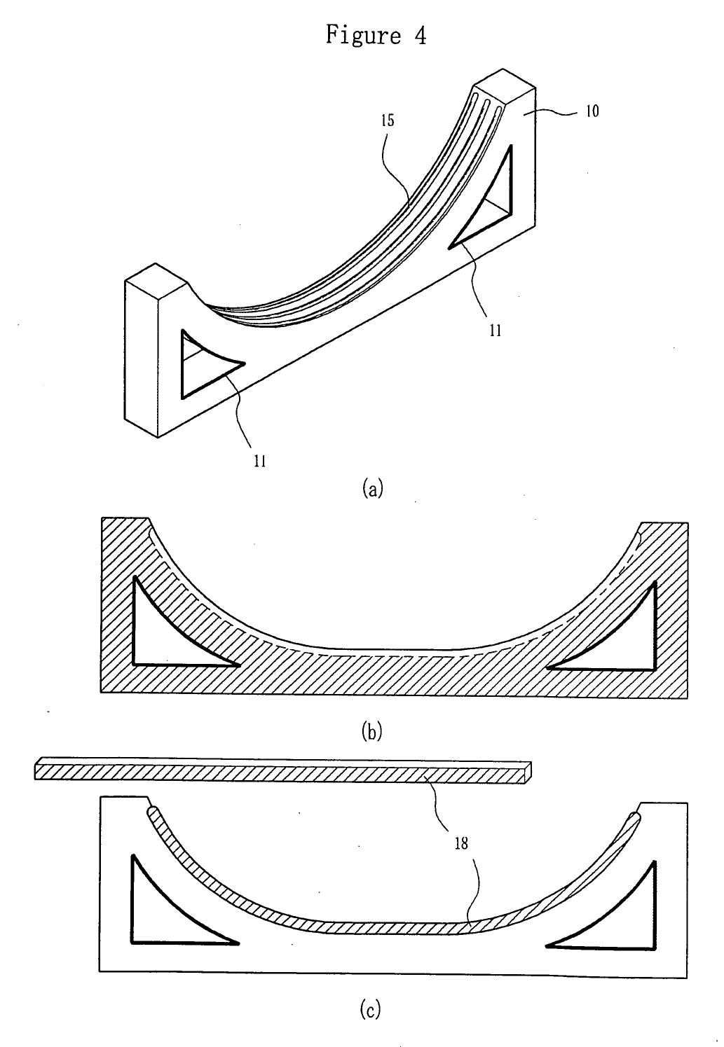

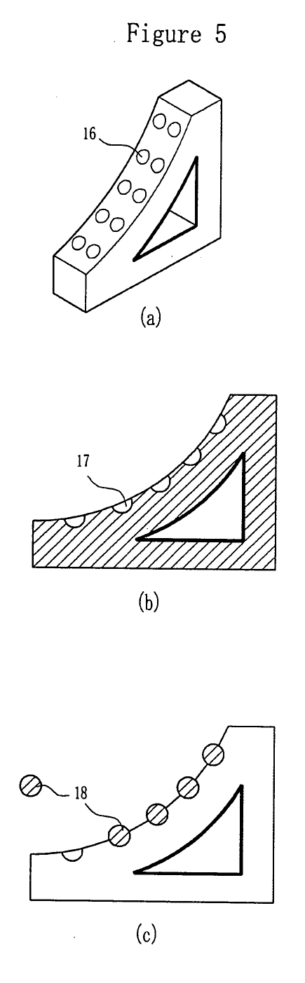

FIG. 2 is a front view illustrating a state that a steel roll is mounted on a MC nylon elastomer support block according to the present invention, FIGS. 3A through 3C are perspective views illustrating a MC nylon elastomer support block according to the present invention, FIGS. 4A through 4C are perspective views illustrating a state that a longitudinal groove is formed in a MC nylon elastomer support block, and FIGS. 5A through 5C are perspective views illustrating a state that a spherical or semispherical groove is formed in a MC nylon elastomer support block according to the present invention.

The synthetic rubber or natural rubber is formed in the same shape as the groove formed in the block and is inserted into the above groove, which leads to enhancing an intermediate impact absorbing function.

The MC nylon elastomer support block, which is a main material of the support block of the present invention, is manufactured through a casting process. The MC nylon elastomer of the present invention is manufactured in a double ion polymerization process by using lactam, polyester polyol or poly ether polyol under a dry nitrogen environment.

Since the lactam is mixed with polyester polyol or poly ether polyol, it is possible to greatly enhance an impact resistance performance.

The monomer, which is the material of MC nylon of the present invention, is prepared by drying caprolactam or laurylolactam (hereinafter referred to lactam) under a vacuum environment with the contents of moisture being below 0.005 weight %. In the synthesis of the nylon block copolymer, polyester polyol or poly ether polyol, which is a kind of prepolymer, is used, with its both ends being substituted with isocyanate instead of isocyanate compound, and with the prepolymer having molecular of above 500. The foams are removed as it is placed under a vacuum environment for above 30 minutes in a vacuum oven of 70° C. before it is used.

The manufacture process of the metal conduit-inserted MC nylon elastomer support block will be described as follows.

The lactam dried under a vacuum environment is inputted into a catalyst tank and an auxiliary catalyst tank, respectively, by the same amount. It is agitated for 3˜5 minutes after catalyst is added to the catalyst tank. Here, a basic catalyst is generally used as the catalyst. As the basic catalyst, alkali metals such as Li, Na, K and Cs and alkali earth metals such as Be, Mg and Ca are used. The rotation speed of the agitator is 500 rpm to 5000 rpm, and the agitating time is 3˜5 minutes, and all the works are performed under a dry nitrogen environment.

A high viscosity prepolymer, which is a reformation polyol, is inputted into the auxiliary catalyst tank and is well mixed with lactam under a nitrogen environment. As the auxiliary catalyst, polyester polyol or poly ether polyol of which both ends are substituted with isocyanate is used. For example, PolyTHF 1800 (MW 1800) manufactured by BASF company, which is PTMG, may be used. As the method of the copolymerization and polymerization mechanism are well described in pages 239 through 248 in Nylon plastics (written by Melvin I. Kohan), when the catalyst of the catalyst tank, a monomer compound and a monomer compound of the auxiliary catalyst tank are polymerized in the anion polymerization mechanism at above 150° C., the MC nylon elastomer having an ABA tri block nylon copolymer with the following formula 1 is synthesized.

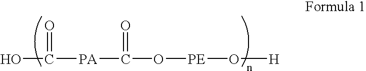

Where PA represents a nylon polymer, and PE represents a poly ether, and n represents a repeating unit.

In the prepolymer used in the synthesis, the molecular amount MW of the polyol is 1000 to 5000, and both ends are substituted (capped) with toluene isocyanate (TDI) or methyl diisocyanate (MDI), and the amount of NCO is 20˜50 weight % of viscosity liquid. The amount of the poly ether which is a prepolymer in the nylon elastomer is 4˜10 weight % as compared to 100 weight % of lactam.

The mixed lactam in the catalyst tank and the auxiliary catalyst tank is inputted into the mixing tank heated up to 80˜120° C. and is well agitates and mixed for 4˜7 minutes. The mold formed in the same shape as the MC nylon elastomer support block is previously heated up to 140˜180° C., and then a triangle or circular steel conduit is heated up to 100˜150° C. and is inputted into the mold. The mixed lactam is inputted into the mold and is polymerized while being changed from liquid state to solid state for a few tens of minutes.

The MC nylon elastomer support block 10 used for a steel transportation vehicle according to the present invention is manufactured by directly inputting nylon elastomer into the mold. So, a process for using the lathe is not needed in the present invention. As shown in FIGS. 3A through 3C, the MC nylon elastomer support block 10 may be provided in a pair in left and right sides. The left and right sides of the same may be integrated into one support block. The MC nylon elastomer support block 10 is provided with a triangle steel plate 11 or a circular steel plate 12. At least two fixing holes 14 are formed in the MC nylon elastomer support block 10 used for a transportation vehicle. The MC nylon elastomer support block 10 can be detachably fixed in the loading plate 5 by using the fixing holes 14.

When the MC nylon elastomer support block 10 is manufactured, the steel conduits 11 and 12 are inserted, and the synthesis is performed, so the steel conduits 11 and 12 can be easily inserted into the MC nylon elastomer support block 10, which leads to more enhancing the support force of the support block. In addition, the MC nylon elastomer support block 10 can be made light.

Since the steel conduits 11 and 12 are inserted into the MC nylon elastomer support block 10, the structure itself can have a substantial support force. The fixing holes 14 may be formed in the Mc nylon elastomer support block for more stably supporting the block with respect to left and right movements of the heavy steel product. So, it is possible to easily detachably fix on the loading plate 5.

As shown in FIGS. 4A through 4C, a longitudinal groove 15 or a spherical groove 16 or a semispherical groove 17 may be integrally formed in the Mc nylon elastomer support block 10 when forming the support block mold. A rod shaped elastomer material is inserted into the longitudinal groove 15, and a semispherical elastomer material or a spherical elastomer material is inserted into the semispherical or spherical elastomer groove, respectively. So, it is possible to increase the adhering force between the large size roll and the MC nylon elastomer support block and to effectively absorb instant impact. It is possible to supplement the elastic force of the MC nylon elastomer support block 10 which is generally hardened due to a low temperature in winter, so the damages of the MC nylon elastomer support block 10, which may occur due to a contact with the large size roll and the MC nylon elastomer support block 10, can be substantially prevented. Here, the rubber may be used for the elastomer material.

The above structure is made of the nylon elastomer which has an excellent mechanical strength and impact strength.

The method for manufacturing a MC nylon elastomer support block which can be used for storing a large size roll or for a vehicle which transports the same according to the present invention comprises a step in which a catalyst tank and an auxiliary catalyst tank both having the same volumes are prepared; a step in which lactam is dried under a vacuum environment to have a moisture content of below 0.005 weight %; a step in which the vacuum-dried lactam is inputted into the catalyst tank and the auxiliary catalyst tank, respectively, by the same amount; a step in which a basic catalyst such as an alkali metal or an alkali earth metal is added into the catalyst tank and is agitated at a rotation speed of 500 rpm to 5000 rpm for 3˜5 minutes under a dry nitrogen environment; a step in which a prepolymer, which is a polymer, of which both ends are substituted with isocyanate, is added into the auxiliary catalyst tank as an auxiliary catalyst by 4˜10 weight % with respect to 100 weight % of lactam, and is mechanically mixed under a dry nitrogen environment; a step in which the mixing tank is heated up to 80˜120° C.; a step in which the lactam mixed with the catalyst in the catalyst tank and the lactam mixed with the auxiliary catalyst in the auxiliary catalyst are inputted into the heated mixing tank and are agitated and well mixed for 4˜7 minutes; a step in which a support block mold is prepared; a step in which the mold is heated up to 140˜180° C.; a step in which the metal conduits 11 and 12 are heated up to 100˜150° C.; and a step in which the heated metal conduits 11 and 12 are installed in the heated mold, and the mixed reaction substance is inputted into between the heated mold and the inserted metal conduits for thereby polymerizing the same.

There is further provided a step in which a longitudinal groove 15 or a spherical groove 15 or semispherical grooves 16 and 17 are formed in the support block shaped mold for inserting an elastomer substance 18 thereinto, respectively.

The MC nylon elastomer support block for a transportation vehicle so manufactured can be detachably fixed on the loading plate 3 by using a bolt or something.

Since the width of the steel roll 1 is commercially standard, the support block according to the present invention can be permanently used once it is installed.

When a large size roll 1 is mounted on the MC nylon elastomer support block 10, the large size roll 1 can be stably fixed in a transportation vehicle even a lot of vibrations or impacts is transferred thereto. Even when the vehicle suddenly stops or swings a lot due to the non-uniform surface of a road while transporting the large size roll 1, it is possible to stably and reliably fix the large size roll 1 while preventing the same from being disengaged from the support block 10.

As described above, in the present invention, it is possible to stably support a large size and heavy roll 1 like a steel coil roll. Even when the vehicle suddenly stops or swings a lot due to the non-uniform surface of a road while transporting the large size roll 1, it is possible to stably and reliably fix the large size roll 1 while preventing the same from being disengaged from the MC nylon elastomer support block 10. Even when the MC nylon elastomer support block is broken, the large size and heavy roll 1 can be stably supported by means of the metal conduits inserted into the MC nylon elastomer support block. In order to more improve the impact strength in the present invention, the MC nylon elastomer is prepared in such a manner that polyol prepolymer is reacted along with lactam with its both end groups being substituted with isocyanate.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A method for manufacturing a MC nylon elastomer support block which can be used for storing a large size roll or for a vehicle which transports the same, comprising:
a step in which a catalyst tank and an auxiliary catalyst tank both having the same volumes are prepared;
a step in which lactam is dried under a vacuum environment to have a moisture content of below 0.005weight%;
a step in which the vacuum-dried lactam is inputted into the catalyst tank and the auxiliary catalyst tank, respectively, by the same amount;
a step in which a basic catalyst such as an alkali metal or an alkali earth metal is added into the catalyst tank and is agitated at a rotation speed of 500 rpm to 5000 rpm for 3˜5 minutes under a dry nitrogen environment;
a step in which a prepolymer, which is a polymer, of which both ends are substituted with isocyanate, is added into the auxiliary catalyst tank as an auxiliary catalyst by 4˜10 weight % with respect to 100 weight % of lactam, and is mechanically mixed under a dry nitrogen environment;
a step in which the mixing tank is heated up to 80˜120° C.;
a step in which the lactam mixed with the catalyst in the catalyst tank and the lactam mixed with the auxiliary catalyst in the auxiliary catalyst are inputted into the heated mixing tank and are agitated and well mixed for 4˜7 minutes;
a step in which a support block mold is prepared;
a step in which the mold is heated up to 140˜180° C.;
a step in which the metal conduits 11 and 12 are heated up to 100˜150° C.; and
a step in which the heated metal conduits 11 and 12 are installed in the heated mold, and the mixed reaction substance is inputted into between the heated mold and the inserted metal conduits for thereby polymerizing the same.

2. The method of claim 1, further comprising a step in which a longitudinal groove 15 or a spherical groove 15 or semispherical grooves 16 and 17 are formed in the support block shaped mold for inserting an elastomer substance 18 thereinto, respectively.

3. The method of claim 2, wherein an elastomer substance 18 is inserted into the grooves 15, 16, and 17 of the nylon elastomer support block 20, respectively.

4. A MC nylon elastomer support block which can be used for storing a large size roll or for a vehicle which transports, which is manufactured based on the method of claim 1.
